(19) United States
(12) Patent Application Publication
(10) Pub. No.: US 2019/0183197 A1
(43) Pub. Date: Jun. 20, 2019

(54) HEAT RELEASING GARMENT LINER

(71) Applicant: HONEYWELL INTERNATIONAL INC., Morris Plains, NJ (US)

(72) Inventors: Alan W. SCHIERENBECK, Dayton, OH (US); Skylar D. HINKLE, Dayton, OH (US); Robin D. SLATER, Sidney, OH (US); Linda M. MOODIE, Miamisburg, OH (US)

(73) Assignee: HONEYWELL INTERNATIONAL INC., Morris Plains, NJ (US)

(21) Appl. No.: 16/218,717

(22) Filed: Dec. 13, 2018

Related U.S. Application Data
(60) Provisional application No. 62/598,911, filed on Dec. 14, 2017.

(51) Int. Cl. A41D 31/08; A41D 27/28

(52) U.S. Cl. CPC A41D 31/085; A62B 17/003; A41D 27/28

(57) ABSTRACT

Embodiments described herein related generally to a multi-layer garment liner including an inner layer and an adjacent layer joined together around a periphery with a heat trapping space between the inner and adjacent layers. A plurality of inlet vents in the inner layer are configured to direct air from outside of the liner/garment into the heat trapping space. The inlet vents can be located in a lower part of the liner/garment. A plurality of outlet vents in the inner layer are configured to direct air from the heat trapping space to outside of the liner/garment. The outlet vents can be located in an upper part of the garment liner. The multi-layer garment liner can further include a plurality of elongate spacer strips located in the heat trapping space, the spacer strips arranged to direct an airflow from the inlet vents toward the outlet vents.

### CROSS-REFERENCE TO RELATED APPLICATIONS

This application claims priority to and the benefit of U.S. Provisional Patent Application No. 62/598,911, entitled “Heat Releasing Garment Liner,” filed Dec. 14, 2017, the disclosure of which is hereby incorporated by reference herein in its entirety for all purposes.

### FIELD OF THE INVENTION

This disclosure relates to multi-layer garments, and in more particular applications to protective overcoats and jackets worn by firefighters and other emergency responders, such as, for example, multi-layer garments commonly referred to as “turn-out coats”.

### BACKGROUND

Over-garments that are worn to protect individuals from environmental exposure are often times comprised of multiple layers of various materials depending on the type of adverse conditions the garments are designed to protect against. Often such garments are worn while the persons are performing some type of vigorous physical activity, such as work or sports, which entail the use of highly developed motor skills being applied with a great degree of mental awareness.

Conventional multi-layer over-garments can moderately or even severely limit a body's core temperature rise through its usual methods of radiation, perspiration, and evaporative cooling of condensed perspiration. Heat from both the external environment and the heat and water vapor given off by the body (internal environment) can become trapped within the layers of a multi-layer garment so that even when the front closures of the garment are opened or partially loosened to release heat between the body and inner most layer of the garment, the heat trapped inside the layers and between the layers of the garment does not easily escape. This internally trapped heat and moisture vapor further reduces the effectiveness of both the garment and wearers' body to mitigate core temperature rise even after the vigorous activity portion of the wearer's work cycle is complete This is of particular concern when the garments are worn for extended periods of time, and during repeated sessions of vigorous physical exertion. A rise in body core temperature of just a few degrees further exacerbates the efforts of the wearer to accomplish the tasks intended. Elevated body core temperature contributes to adverse effects such as: dehydration from perspiration; reduced speed and accuracy in making mental judgments; physical and mental fatigue; and reduction in fine motor skills and reaction times; and can result in heat prostration, heat stroke, heart attacks and aneurisms/strokes.

The above concerns and issues are particularly important for firefighters and other emergency responders who utilize multi-layer garments as protective gear while performing physically demanding tasks, often in very high temperature environments. A high percentage of firefighter injuries and fatalities while operating at a fire ground scene can be linked to heat stress, whether it be the direct biological effect of heat to the body's systems and/or impaired judgment and decision making processes that begin almost immediately with very little body core temperature rise, all the way to the biological failure points such as heat prostration, heat stroke, heart attack, and aneurism/stroke.

### SUMMARY

The disclosure describes multi-layer liners and multi-layer over-garments with features that allow thermal energy that is normally trapped within the layers of the garment a direct pathway to be expelled from the inside of the garment's innermost layer where it can more effectively circulate and dissipate the heat, and to be released more effectively when the wearer controls the venting of the garment by manipulation of the closures and other devices associated with the garment. The trapped heat load expelled from the garment will be replaced by both cooler and drier air from the exterior of the garment, which will have a positive physiological effect on comfort and body core temperature, as well as the physical performance of a wearer of the over-garment.

The design of the multi-layer garment/liner disclosed herein is based on the ideas that: (1) heat rises; and (2) when warmer air rises within a multi-layer garment/liner and is expelled from outlet vents in an upper/higher area of the garment/liner, the movement of that air will draw cooler and drier air in through inlet vents in a lower portion of the garment/liner. In other words, using the thermodynamic principles related to thermal gas expansion, a direct heat exchange can be accomplished within a heat exchange portion between two layers of the garment, all controllable by the wearer. The release of thermal energy from the outlet vents reduces the work the body of a wearer must do to cool itself and helps the wearer maintain lower body core temperatures for longer periods of time.

In some embodiments, a multi-layer liner/garment is provided and includes an inner layer and an adjacent layer joined together around a periphery with a heat trapping space between the inner and adjacent layers. A plurality of inlet vents in the inner layer are configured to direct air from outside of the liner/garment into the heat trapping space. The inlet vents are located in a lower part of the liner/garment. A plurality of outlet vents in the inner layer are configured to direct air from the heat trapping space to outside of the liner/garment. The outlet vents are located in an upper part of the garment.

In some embodiments, the liner/garment can be selected from among: a coat, a liner for use in an outer shell of a coat, a pant, a liner for use in an outer shell of a pant, a bib overall, a liner for use in an outer shell of a bib overall, a jumpsuit/coverall, a liner for use in an outer shell of a jumpsuit/coverall, combinations thereof, and the like.

In some embodiments, a multi-layer liner is provided for use in an outer shell of a coat or jacket. The liner can include a torso portion configured to surround the torso of a wearer and a pair of sleeves extending from the torso covering portion and configured to surround the arms of the wearer. The liner can include an inner layer and an outer layer joined together around a periphery of the torso portion and around a distal end opening of each sleeve with a heat trapping space between the inner and outer layers extending over the torso covering portion and each sleeve. The periphery can include a bottom edge of the torso portion and a neckline of the torso portion. The liner can include a plurality of inlet vents in the inner layer, the plurality of vents configured to direct air from outside of the liner into the heat trapping space. The inlet vents can be located in a lower part of the torso portion adjacent the bottom edge. The liner can further include a plurality of outlet vents in the inner layer configured to direct air from the heat trapping space to outside of the liner. The outlet vents can be located in an upper part of the torso covering portion between the sleeves and beneath a neckline of the liner.

In some embodiments, the inner layer can have a front configured to extend over a front of a torso of the wearer and a back configured to extend over a back of the torso of the wearer. The inlet and outlet vents can be located in only the front of the inner layer, only the back of the inner layer, a portion of the front of the inner layer and a portion of the back of the inner layer, in all of the back of the inner layer and only a portion of the front of the inner layer, in all of the front of the inner layer and only a portion of the back of the inner layer, or in both the front and the back of the inner layer.

In some embodiments, the inlet vents can be located in the front and the back of the inner layer on either side of a median plane that divides the liner into a left side and a right side. In some embodiments, the outlet vents can be located in the front and the back of the inner layer on either side of the median plane.

According to some embodiments, at least one of the inlet vents and at least one of the outlet vents can be located in the left side of the front of the inner layer, at least one of the inlet vents and at least one of the outlet vents can be located in the right side of the front of the inner layer, at least one of the inlet vents and at least one of the outlet vents can be located in the left side of the back of the inner layer, and/or at least one of the inlet vents and at least one of the outlet vents can be located in the right side of the inner layer.

In some embodiments, the vents are located so that they are symmetric about the median plane. In some embodiments, there is substantially the same number of inlet vents as outlet vents. In some embodiments, the inlet vents outnumber the outlet vents. In some embodiments, the inlet vents and the outlet vents can have substantially the same dimensions with respect to diameter or surface area of the vent openings. In some embodiments, the inlet vents can have a larger dimension than the outlet vents.

In some embodiments, the multi-layer liner can include a second plurality of inlet vents in the inner liner, for example one or more pairs of the second plurality of inlet vents. In some embodiments, one or more of the plurality of additional inlet vents can be located in a first one of the sleeves and another one or more of the plurality of additional inlet vents can be located in a second one of the sleeves. In embodiments in which the multi-layer garment is for pants, one or more of the plurality of additional inlet vents can be located in a first one of a pair of pant legs and another one or more of the plurality of additional inlet vents can be located in a second one of the pair of pant legs.

According to some embodiments, each sleeve can include an underarm bellows located between the torso covering portion and the inlet vent in the sleeve.

In some embodiments, the liner can include a face cloth quilted to a thermal layer, the thermal layer at least partially defining the heat trapping space, e.g., positioned facing away from the wearer.

In some embodiments, each vent can include an opening formed in the inner layer, and a backup panel located on a side of the inner layer facing the heat trapping space overlaying the opening.

According to some embodiments, each of the openings can have an elongate rectangular perimeter.

In some embodiments, the perimeter of each opening can be defined by a welt.

In some embodiments, each backup panel can have a trapezoidal-shaped perimeter.

According to some embodiments, each backup panel can include a face cloth quilted to a thermal layer.

In some embodiments, a plurality of elongated spacer strips can be located in the heat trapping space. In some embodiments, the spacer strips can be arranged to direct an airflow from the inlet vents toward the outlet vents. In some embodiments, the spacer strips can be fixed to the inner layer.

Other features and advantages will become apparent from a review of the entire specification, including the appended claims and drawings.

### BRIEF DESCRIPTION OF THE DRAWINGS

FIG. 1 is a front elevation view of a multi-layer liner according to this disclosure for use in an outer shell of a coat or jacket, with the liner turned inside-out for purposes of illustration to better expose the inner layer of the liner;

FIG. 2 is a back elevation view of the liner of FIG. 1, again with the liner turned inside-out;

FIG. 3 is an enlarged diagrammatic section view taken from line 3-3 in FIG. 1;

FIG. 4 is a plan view of the inner layer of the liner prior to the inner layer being joined to an outer layer of the liner;

FIG. 5 is an enlarged view of a vent in the inner layer shown in FIG. 4;

FIG. 6 is a view similar to FIG. 5, but showing an opposite side of the inner layer and vent;

FIG. 7 is a view similar to FIG. 1, but showing another embodiment of the multi-layer liner according to this disclosure;

FIG. 8 is a back view of the multi-layer liner of FIG. 7; and

FIG. 9 is a front view of the multi-layer liner of FIGS. 7 and 8 as installed in the outer shell of a firefighters turn-out coat.

### DETAILED DESCRIPTION

Garments and liners for garments are disclosed generally herein, and particularly, liners having a heat trapping space between two layers of the liner and inlet/outlet vents configured to vent out hotter, more humid air from inside the garment and draw in cooler, drier air from outside the garment.

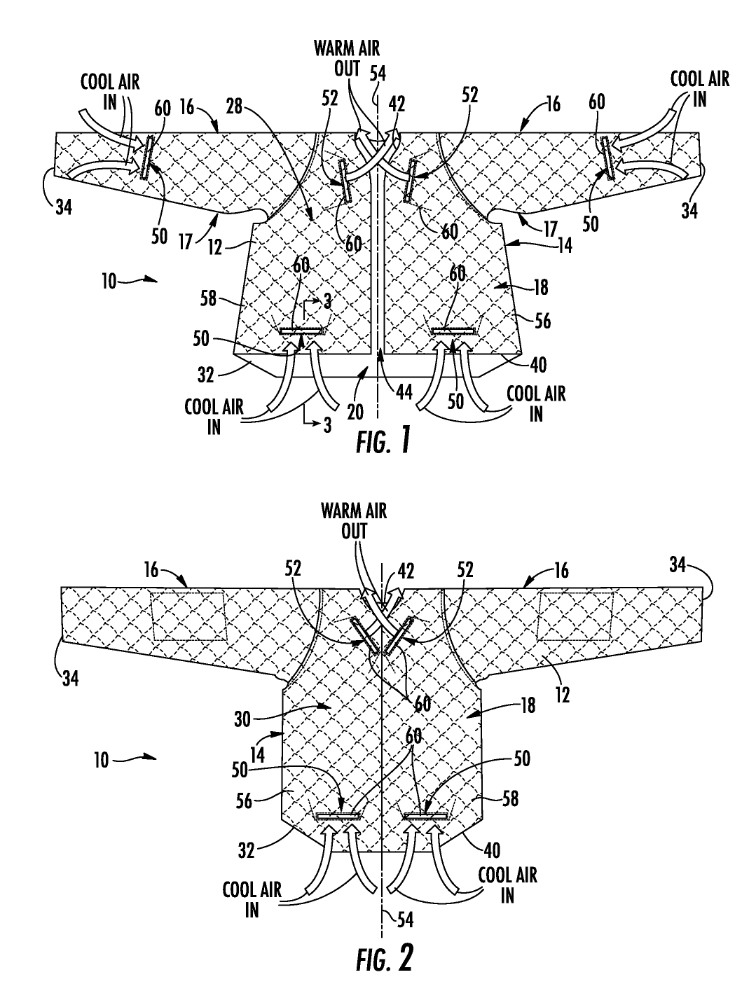

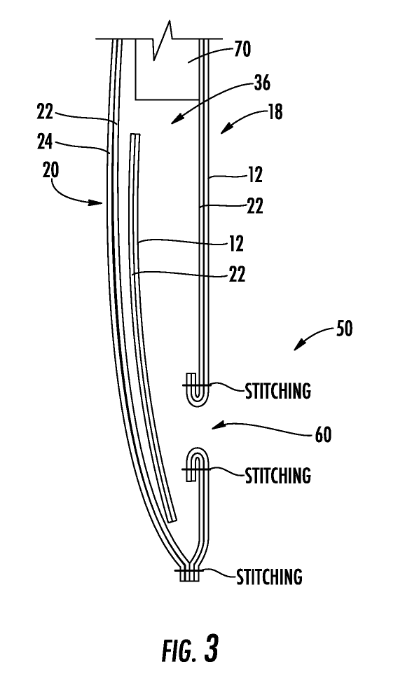

With reference to FIGS. 1 and 2, a multi-layer garment is shown in the form of a multi-layer liner 10 provided for use in an outer shell of a coat or jacket, with the illustrated liner 10 being particularly adapted for use in the outer shell of a “turn-out coat” used by firefighters and other emergency responders. The liner 10 in FIGS. 1 and 2 is shown “inside-out” so that the surface 12 of the liner 10 that would be facing a wearer can be seen. In the illustrated embodiment, the surface 12 is provided in the form of a “facecloth”, as is commonly employed in multi-layer liners for turn-out coats worn by firefighters and other emergency responders. The liner 10 has a torso portion 14 configured to surround the torso of a wearer and a pair of sleeves 16 extending from the torso portion 14 to surround the arms of a wearer. In the illustrated embodiment, each of the sleeves 16 include underarm bellows 17, which is a significant oversizing of the sleeve in the area of the sleeve that would surround at least a portion of the armpit, bicep, and tricep of a wearer in order to provide a wearer increased freedom of movement of their body while minimizing corresponding movement of the ends of the sleeve (cuffs) with respect to the wrists of the moving wearer.

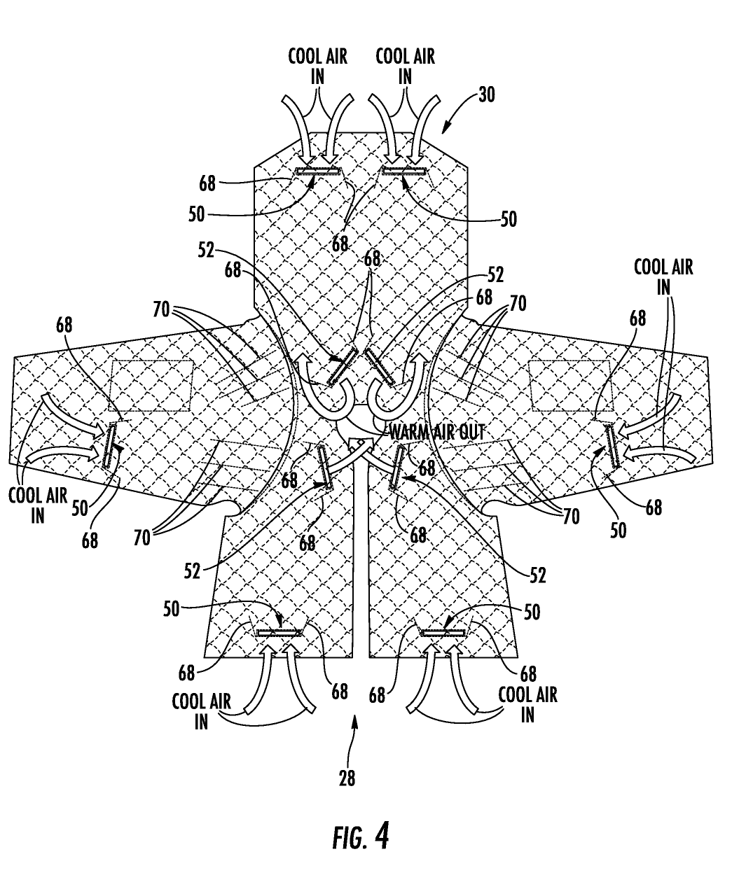

As shown in FIG. 3, the liner 10 includes an inner layer 18 and an outer layer 20, both of which extend over the entirety of the torso portion 14 and sleeves 16. In the illustrated embodiment, the inner layer 18 includes the facecloth 12 and an insulating layer, shown diagrammatically at 22 in FIG. 3, which is quilted to the facecloth 12. The outer layer 20 is provided in the form of a moisture barrier that includes a substrate, shown diagrammatically at 24 in FIG. 3, which faces away from a wearer and a film, shown diagrammatically at 26, that faces toward this inner layer 18. The torso portion 14 has a front 28 shown in FIG. 1 configured to extend over a front of a torso of a wearer, and a back 30 shown in FIG. 2 configured to extend over the back of the torso of a wearer. Both the inner layer 18 and the outer layer 20 extend over the entirety of both sleeves 16 and the torso portion 14, and accordingly, both the inner and outer layers 18 and 20 have a torso portion 14 with a front 28 and a back 30, and a pair of sleeves 16.

In some embodiments, the inner and outer layers 18 and 20 can be joined together by stitched seams around a periphery 32 of the torso portion 14 and around distal end openings/cuff openings 34 of each sleeve 16, with a heat trapping space 36 (e.g., as shown in FIG. 3) between the inner and outer layers 18 and 20 extending over the torso covering portion 14 and each sleeve 16. The periphery 32 includes a bottommost edge 40 of the torso portion 14, a neckline 42 of the torso portion 14, and in the illustrated embodiment, an elongate central opening 44 extending over the height of the torso portion 14 to allow the wearer to more easily don and doff the liner 10. It should be understood that the heat trapping space 36 extends from each sleeve into the torso portion 14 and that the inner layer 18 and outer layer 20 are not or not necessarily joined together at the location where the sleeves 16 are connected to the torso portion 14. In this regard, the sleeves 16 of the inner layer 18 can be attached to the torso covering portion 14 of the inner layer 18, and the sleeves 16 of the outer layer 20 can be attached to the torso covering portion 14 of the outer layer 20.

The liner 10 can further include a plurality of inlet vents 50 in the inner layer 18, the plurality of inlet vents 50 configured to direct air from outside of the liner 10 into the heat trapping space 36. The plurality of inlet vents 50 can be located in any suitable location of the liner 10, e.g., in a lower part of the torso covering portion 14, adjacent the bottom edge 40. In the illustrated embodiment, for example, an inlet vent 50 is also provided in each of the sleeves 16. The liner 10 can also include a plurality of outlet vents 52 in the inner layer 18, the plurality of outlet vents 52 configured to direct air from the heat trapping space 36 to outside of the liner 10. In the illustrated embodiment, for example, the outlet vents 52 are located in an upper part of the torso covering portion 14, between the sleeves 16 and beneath the neckline of the liner 10, however the plurality of outlet vents 52 can be located in any suitable positon on the liner 10.

In the illustrated embodiment, the vents 50 and 52 are located/arranged so that they are approximately symmetric about a meridian plane, shown schematically by line 54, that divides the liner 10 into a left side 56 and a right side 58. In this regard, the inlet vents 50 in each sleeve 16 are located in the identical location in each sleeve 16, one inlet vent 50 and one outlet vent 52 are provided on the right side 58 of the front 28 of the inner layer 18, an inlet vent 50 and an outlet vent 52 are provided of the left side 56 of the front 28 of the inner layer 18, an inlet vent 50 and an outlet vent 52 are provided on the right side 58 of the back 30 of the inner layer 18, and an inlet vent 50 and an outlet vent 52 are provided on the left side 56 of the back 30 of the inner layer 18.

Other configurations of the vents 50 and 52 are possible, and in some embodiments, may be preferable. For instance, the primary orientation of the garment/liner may relate to the specific application of use and use environment for the garment/liner. By way of example only, if the primary orientation of the garment is with the neckline of the liner 10 facing “up” and the bottom edge of the torso covering portion facing “down,” then the illustrated configuration of the vents 50 and 52 with respect to the thermodynamic venting of expanding hot gas from the garment/liner 10 may be sufficient. However, if the primary orientation was such that the sleeves 16 are facing “up” and “down” due to a horizontal primary application or wearer orientation during use, then alternative placement of the vents 50 and 52 would likely be needed to achieve the thermodynamics of expanding gases necessary to cool the wearer during use of the garment/liner. Therefore, the location, number, size, and other characteristics of the vents 50 and 52 are provided herein for illustrative purposes only for a select subset of possible embodiments, and one of skill in the art will readily understand based on the above alternative embodiment, that many other configurations and dimensions are possible.

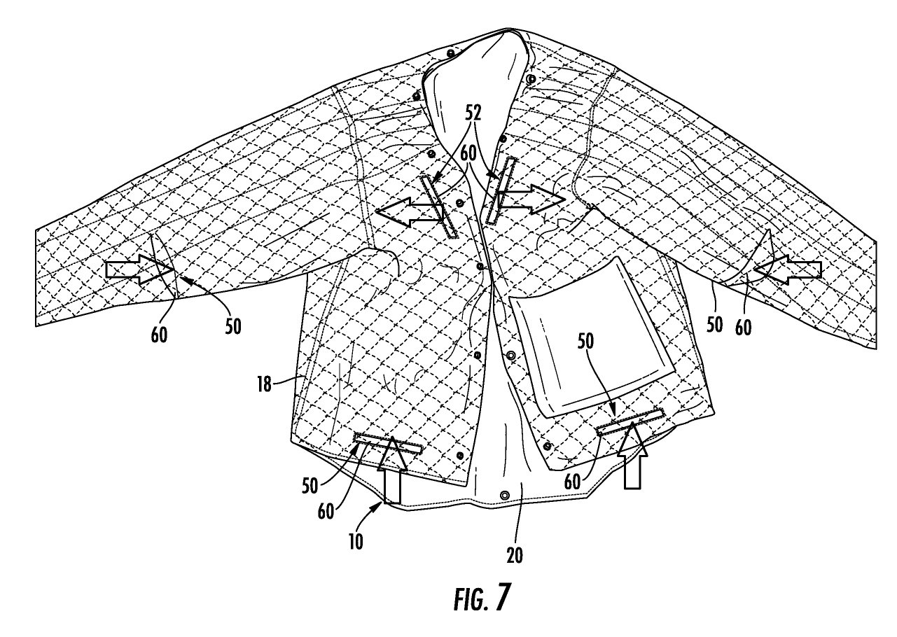

As seen in FIGS. 3-5, each of the vents 50 and 52 can include an opening 60 formed in the inner layer 18 and a backup panel 62 that overlays the opening 60 and is located on the side of the inner layer 18 facing the heat trapping space 36. In the illustrated embodiment, each of the openings 60 has an elongate rectangular perimeter 64 that is defined by a welt or other suitable edge hem. In the embodiment of FIGS. 1-6, the opening 60 of the inlet vents 50 in the front 28 and back 30 of the inner layer 18 are elongate in a horizontal direction, while the openings 60 of the inlet vents 50 in the sleeves 16 are elongated approximately parallel to the end of the sleeves 16. The elongate length of the openings 60 of the outlet vents 52 in the front 28 of the inner layer 18 are arranged at an acute angle relative to each other, and the elongate length of the opening 60 of the outlet vents 52 in the back 30 are also arranged at an acute angle relative to each other. Unexpectedly, it has been found that this particular arrangement of the openings 60 provides a significant increase in air flow through the vents 50 and 52 and into and out of the heat trapping space 36.

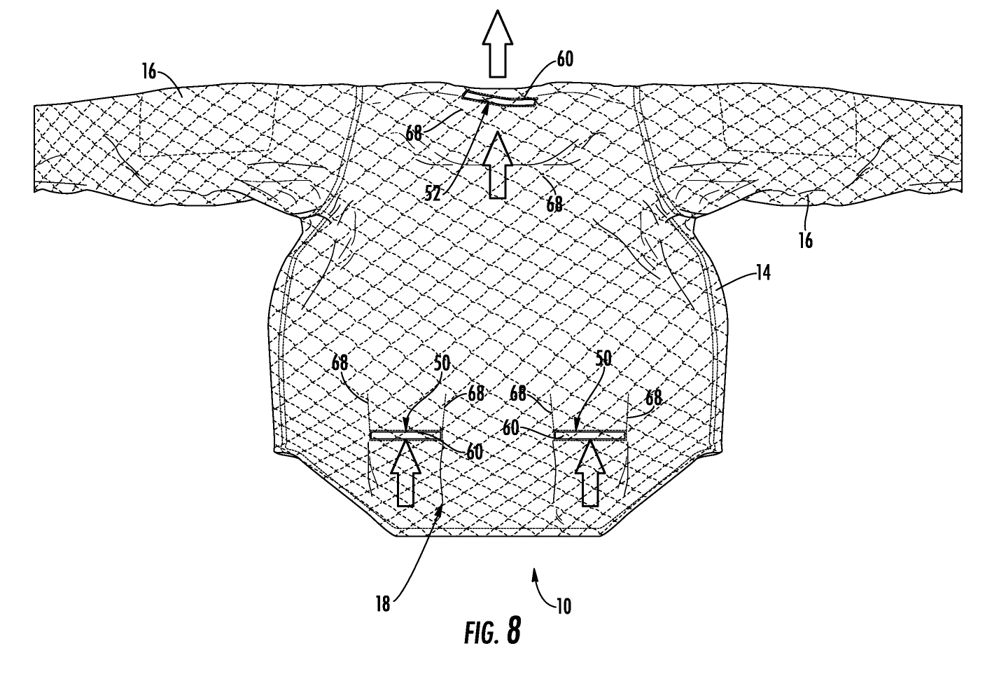

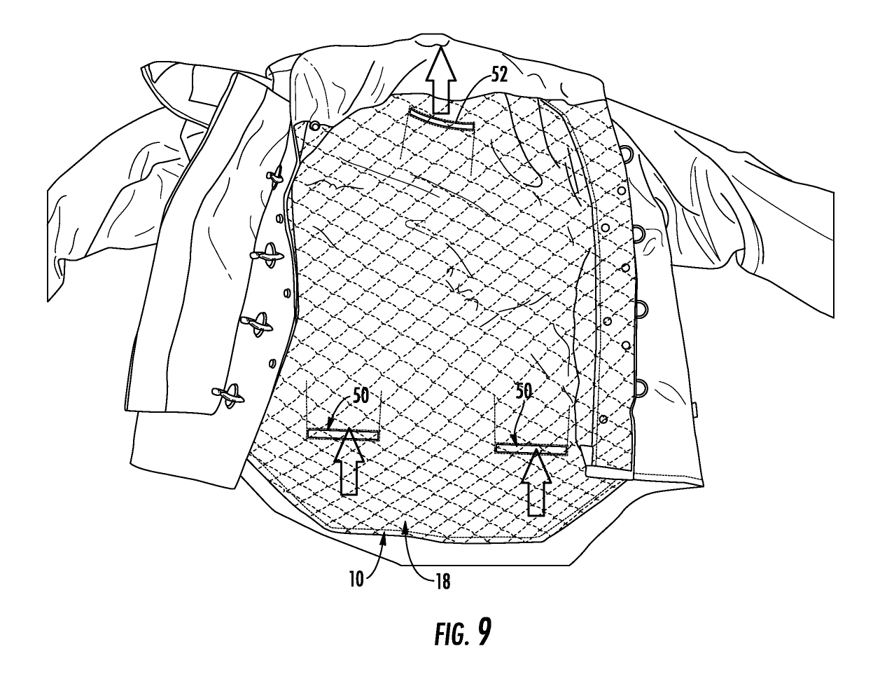

The vents 50 and 52 on the embodiment of the liner 10 shown in FIGS. 7-9 are also similarly arranged, with the exception that the outlet vent 52 in the back 30 of the inner layer 18 is arranged so that the elongate length of the opening 60 runs in a horizontal direction. In the embodiment shown in FIGS. 1-6, each of the backup panels 62 has a trapezoidal-shaped perimeter 66 with the shorter base of the trapezoid being located adjacent the opening 60 and the larger base of the trapezoid being spaced from the opening 60. The diagonal legs of the trapezoidal perimeter 66 are fixed to the inner layer 18 by any suitable means, which will typically be a line of stitching 68.

In some applications, it may be also desirable for the shorter base of the trapezoidal perimeter 66 to also be fixed to the inner layer 18 by suitable means, which again will typically be a line of stitching. Unexpectedly, it has been determined that the trapezoidal shape of the back panel 62 improves the distribution of the air from the inlet vents 50 into the heat trapping space 36 and improves the exhaustion of the air from the heat trapping space 36 via the outlet vents 52. As illustrated by the lines of stitching 68 in FIGS. 7-9, the embodiment of the liner 10 shown in FIGS. 7-9 utilizes backup panels 62 that have rectangular-shaped perimeters, rather than trapezoidal-shaped.

Each of the backup panels 62 overlays the opening 60 of the corresponding vents 50 and 52 on the insulating layer side of the inner layer 18 so that the liner 10 still provides the required protection/protective qualities that would otherwise be inhibited or reduced by the opening 60. In some embodiments, each of the back panels 62 can utilize the same material and construction as the inner layer 18, with each backup panel having a facecloth 12 that is quilted to a thermal layer 22, e.g., as seen in FIG. 3.

It should be understood that the structure of the vent 50 shown in FIG. 3 can be consistent with the structure of the other vents 50 and 52 discussed in this disclosure.

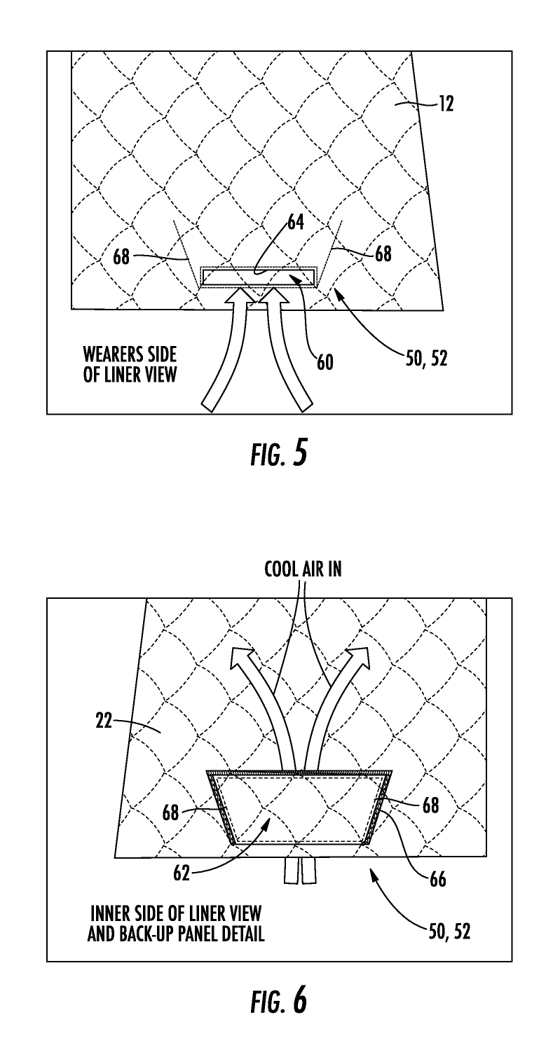

The liner 10 can also include elongate spacer strips, shown diagrammatically by dashed lines 70 in FIG. 4, that are located in areas of the liner 10 that might be compressed by equipment utilized by the wearer, such as the shoulder straps of a self-contained breathing apparatus (SCBA), and/or areas where the outer layer 20 may be pressed against the inner layer 18. Advantageously and unexpectedly, it was found that such spacer strips 70, if carefully dimensioned, configured, and positioned in the heat trapping space 36 in a particular manner, can increase the communication of an air flow from the inlet vents 50 toward the outlet vents 52, and more specifically, from the exit of a backup panel 62 of an inlet vent 50 to the inlet of a backup panel 62 of an outlet vent 52, as illustrated by the dashed lines 70 in FIG. 4. Some alternative dimensions, configurations, and positions for the inlet vents 50, outlet vents 52, and spacer strips 70 did not exhibit the advantages described herein, while other configurations provided a similar or slightly reduced benefit in terms of air flow.

The liner 10 can utilize any suitable materials for the inner and outer layers 18 and 20, and the backup panels 62. For instance, the materials utilized for the liner 10, including the inner layer 18, the outer layer 20, and the backup panels 62, can include any of the materials typically used for liners in firefighter turn-out coats.

When it is favorable/advisable to stop the air flow, such as during interior firefighting or subzero physical activities in cold weather, it can be advantageous to be able to close or partially close the vents 50 and 52. Thus, in some embodiments, the garment/liner 10 can include take-up straps and/or a waist belt on, or exterior to, the garment/liner 10 to block the lower liner vents 50. In some embodiments, conversely, a garment/liner 10 front closure and a collar closure can be configured to stop the expelling/exchange process too. In other words, the inlet vents 50 can be blocked or closed by straps or a belt and the outlet vents 52 can be blocked or closed by tightening the jacket about portions of the wearers body, e.g., by tightening the neckline about the wearer's neck, by tightening the torso covering portion about the wearer's torso and/or by tightening the bottom edge about the wearer's waist. However, blocking or closing the vents 50 and 52, which may slow or stop the heat exchange and air flow processes with the outside atmosphere, does not fully eliminate all of the benefits. Even closed, the vents 50 and 52 will facilitate increased internal circulation of the air that is now trapped between the wearer and garment/liner 10, as well as the air and thermal energy within or between the layers of the garment/liner 10.

It should be understood that while this disclosure uses firefighting garments as one desirable example, the features disclosed herein can find use in any multi-layer over-garment, including coats, pants, bib overalls, jumpsuits, or the like. In many but not all applications, it will be desirable that there be one or more outlet vents 52 placed high up on the garments' inner layers/liner, and at least one or more inlet vents 50 place down low near the hem of the garments' inner layers/liner.

As used herein, a “vent” is defined as any opening or device that allows for much higher air flow than provided for by the base material itself (the material of the inner layer 18 in which the vent is located). In most applications, it will be desirable for the opening 60 to have a backup panel 62 or other mechanism that provides an equal level of protective value as the base material itself without the opening 60. The backup panel material used to provide the equal or greater level of protective value can be identical or dissimilar to the base material, comprised of woven, knit, mesh, batting, or any combination of such materials.

To maximize the amount of air circulation, the width and length of each opening 60 should be as large as practical for each location, and where the possibility any gaps in the protective value of the liner 10 may occur a backup panel or mechanism of equal or greater protection should be provided to eliminate any gap in protective value.

Unlike currently available garments and liners, the garments and liners disclosed herein allow trapped heat within the garment layers to escape while at the same time ensuring the overall integrity of the protective envelop. For applications and embodiments for which the garment/liner 10 will serve a primarily protective function, e.g., for firefighter's jackets, it is important that the inclusion of vents 50 and 52 not diminish the protective ability of the garment/liner 10. Thus, in addition to the surprising increases in air flow stemming from the dimensions, configurations, and positions of vents in many of the embodiments described herein, many embodiments of the garment/liner 10 include features specifically suited to facilitate enhanced protection of the wearer. For instance, in some embodiments, the offset placement of the vents 50 and 52 is not important solely because of the thermodynamics of hot air rising through the garment/liner 10 layers and drawing cooler air into the garment/liner 10, but is also important because it disallows direct interaction with the wearer and hazardous environments. Further, in some embodiments, the backup panel 62 and the stiching at the vent openings can result in a vent opening that remains substantially abutted (flush) against the backup panel 62, meaning debris, dust, embers, dirt, and other undesirable contaminants and materials remain outside the garment/liner 10 while air readily enters through the vent opening. The vent features are inexpensive and easy to manufacture, can use the same materials that a garment is already made from, can utilize the same automated equipment as already utilized in current production, and is so effective that a wearer can actually “feel” it working.

Prototypes of the liner 10 have shown that a wearer can actually feel the movement of air through the vents 50 and 52 and into and out of the heat trapping space 36. Surprisingly, it has also been discovered that the movement of the wearer's arms relative to the wearer's torso during normal use of the liner 10 creates a “pumping” action that increases the flow of air through the vents 50 and 52 and into and out of the heat trapping space 36. Without wishing to be bound by any particular theory, it is believed this “pumping” action may be enhanced further by the inclusion of the underarm bellows 17 in the liner 10. In use, after undergoing a cycle of heavy physical exertion while wearing a multi-layer garment/liner 10, a wearer can open up the outer shell of the garment at the neckline and via the front opening of the outer shell and can loosen any belts or other straps of equipment that is being utilized by the wearer in order to further increase the air flow through the vents 50 and 52. Intermittent loosing of the garment at the neckline and the front opening of the outer shell and loosening of any belts or other straps of equipment, significantly improves the micro-climate within the multi-layer garment/liner 10 during the next period of time when the wearer must close and tighten all of the openings of the outer shell of the garment in order for the garment to provide adequate protection in a hazardous environment.

The following are examples of the subject matter that can be claimed by this disclosure. It should be understood that the following does not in any way limit the subject matter that may be claimed in connection with this disclosure.

In some embodiments, a multi-layer liner 10 for use in an outer shell of a coat or jacket can include a torso portion 14 configured to at least partially surround the torso of a wearer and a pair of sleeves 16 extending from the torso covering portion and configured to at least partially surround the arms of a wearer. In some embodiments, the multi-layer line 10 can further include an inner layer 18 and an outer layer 20. In some embodiments, the inner layer 18 and the outer layer 20 can be joined together around a periphery 32 of the torso portion 14 and around a distal end opening 60 of each sleeve with a heat trapping space 36 between the inner and outer layers 18 and 20 extending over the torso covering portion 14 and each sleeve 16. In some embodiments, the periphery 32 can define or include a bottom edge of the torso portion 14 and a neckline of the torso portion 14.

In some embodiments, the multi-layer liner 10 can include means for venting hot air from the heat trapping space 36. In some embodiments, a plurality of inlet vents 50 can be defined in the inner layer 18. In some embodiments, the plurality of inlet vents 50 can be configured to direct air from outside of the liner 10 into the heat trapping space 36. In some embodiments, the inlet vents 50 can be located in a lower part of the torso covering portion adjacent the bottom edge.

In some embodiments, a plurality of outlet vents 52 in the inner layer 18 configured to direct air from the heat trapping space 36 to outside of the liner 10, the outlet vents 52 located in an upper part of the torso covering portion between the sleeves 16 and beneath a neckline of the liner 10.

In some embodiments, the inner layer 18 can have a front configured to extend over at least a portion of a front of a torso of a wearer and a back configured to extend over at least a portion of the back of the torso of the wearer, and the inlet and outlet vents 52 are located in both the front and the back of the inner layer 18. In some embodiments, the inlet vents 50 can be located in the front and the back of the inner layer 18 on either side of a median plane that divides the liner 10 into a left side 56 and a right side 58. In some embodiments, the outlet vents 52 can be located in the front and the back of the inner layer 18 on either side of the median plane. In some embodiments, at least one of the inlet vents 50 and at least one of the outlet vents 52 can be located in the left side 56 of the front of the inner layer 18. In some embodiments, at least one of the inlet vents 50 and at least one of the outlet vents 52 can be located in the right side 58 of the front of the inner layer 18. In some embodiments, at least one of the inlet vents 50 and at least one of the outlet vents 52 can be located in the left side 56 of the back of the inner layer 18. In some embodiments, at least one of the inlet vents 50 and at least one of the outlet vents 52 can be located in the right side 58 of the inner layer 18. In some embodiments, the vents can be located so that they are symmetric about the median plane.

In some embodiments, the liner 10 can include additional vents, such as a pair of additional inlet vents 50 in the inner liner 10. In some embodiments, the liner 10 can include a first pair of additional inlet vents 50 located in one of the sleeves 16 and a second pair of additional inlet vents 50 located in the other of the sleeves 16. In some embodiments, at least one sleeve can include underarm bellows located between the torso covering portion 14 and the inlet vent 50 in the sleeve 16.

In some alternative embodiments, a garment can include a multi-layer liner. In some embodiments, the multi-layer liner can include an inner layer 18 and an adjacent layer joined together around a periphery 32 with a heat trapping space 36 between the inner and adjacent layers. In some embodiments, the multi-layer liner can include a plurality of inlet vents 50 in the inner layer 18 configured to direct air from outside of the liner/garment into the heat trapping space 36. In some embodiments, the inlet vents 50 can be located in a lower part of the liner/garment. In some embodiments, the multi-layer liner can include a plurality of outlet vents 52 in the inner layer 18 configured to direct air from the heat trapping space 36 to outside of the liner/garment. In some embodiments, the outlet vents 52 can be located in an upper part of the garment.

In some embodiments, the garment can be at least one of a coat, a liner 10 for use in an outer shell of a coat, a pant, a liner 10 for use in an outer shell of a pant, a bib overall, a liner 10 for use in an outer shell of a bib overall, a jumpsuit/coverall, and/or a liner 10 for use in an outer shell of a jumpsuit/coverall. In some embodiments, the liner 10 can include a face cloth quilted to a thermal layer, the thermal layer facing the heat trapping space 36.

In some embodiments, vents, as described herein, can include an opening 60 formed in the inner layer 18 and a backup panel overlaying the opening 60 and located on a side of the inner layer 18 facing the heat trapping space 36. In some embodiments, one or more of the openings 60 can have an elongate rectangular perimeter. In some embodiments, one or more of the openings 60 can be defined by a welt. In some embodiments, the backup panel can include a trapezoidal-shaped perimeter. In some embodiments, the backup panel can include a face cloth quilted to a thermal layer.

In some embodiments, the liner 10 can include a plurality of elongate spacer strips located in the heat trapping space 36. In some embodiments, the spacer strips can be arranged to direct an airflow from the inlet vents 50 toward the outlet vents 52. In some embodiments, the spacer strips can be fixed to the inner layer 18.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” Any ranges cited herein are inclusive of all values and subranges therewithin.

The terms “substantially” and “about” used throughout this Specification are used to describe and account for small fluctuations. For example, they may refer to less than or equal to +5%, such as less than or equal to +2%, such as less than or equal to +1%, such as less than or equal to +0.5%, such as less than or equal to +0.2%, such as less than or equal to +0.1%, such as less than or equal to +0.05%.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” may refer, in some embodiments, to A only (optionally including elements other than B); in some embodiments, to B only (optionally including elements other than A); in yet some embodiments, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of” or “exactly one of ” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) may refer, in some embodiments, to at least one, optionally including more than one, A, with no B present (and optionally including elements other than B); in some embodiments, to at least one, optionally including more than one, B, with no A present (and optionally including elements other than A); in yet some embodiments, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A liner for an outer shell of a garment, the garment comprising two sleeves, each sleeve coupled to a torso portion at a proximal end and a cuff at a proximal end, the torso portion comprising a bottom edge and a neckline, the liner comprising:
an inner layer and an outer layer joined together at a periphery of the liner and at the cuff of each of the two sleeves of the liner, and a heat trapping space at least partially defined between the inner layer and the outer layer;
a plurality of inlet vents defined in the inner layer, the plurality of inlet vents configured to communicate air from outside of the liner into the heat trapping space, the inlet vents located in a lower part of the torso portion adjacent the bottom edge; and
a plurality of outlet vents defined in the inner layer, the plurality of outlet vents configured to communicate air from the heat trapping space to outside of the liner, the outlet vents located in an upper part of the torso portion above the lower part of the torso portion.

2. The liner of claim 1, wherein the plurality of outlet vents are located between the sleeves and beneath a neckline of the liner.

3. The liner of claim 1, wherein the inner layer has a front configured to extend over a front of a torso of a wearer and a back configured to extend over a back of the torso of the wearer, and wherein the inlet and outlet vents are located in both the front and the back of the inner layer.

4. The liner of claim 3, wherein the inlet vents are located in the front and the back of the inner layer in either side of a median plane that divides the liner into a left side and a right side, and the outlet vents are located in the front and the back of the inner layer in either side of the median plane.

5. The liner of claim of claim 4, wherein one of the inlet vents and one of the outlet vents are located in the left side of the front of the inner layer, one of the inlet vents and one of the outlet vents is located in the right side of the front of the inner layer, one of the inlet vents and one of the outlet vents is located in the left side of the back of the inner layer, and one of the inlet vents and one of the outlet vents is located in the right side of the inner layer.

6. (canceled)

7. The liner of claim 1, further comprising:
a second plurality of inlet vents defined in the inner liner, one of the inlet vents located in one of the sleeves and the other of the inlet vents located in the other of the sleeves.

8. The liner of claim 7, wherein each sleeve has an underarm bellows located between the torso covering portion and the inlet vent in the sleeve.

9. A multi-layer liner for use in an outer shell of a coat or jacket, the multi-layer liner having a torso portion to surround the torso of a wearer and a pair of sleeves extending from the torso covering portion to surround the arms of a wearer, the liner comprising:
an inner layer and an outer layer joined together around a periphery of the liner and at a cuff of each sleeve with a heat trapping space between the inner and outer layers extending over the torso covering portion and each sleeve, the periphery including a bottom edge of the torso portion and a neckline of the torso portion;
a plurality of inlet vents in the inner layer configured to direct air from outside of the liner into the heat trapping space, the inlet vents located in a lower part of the torso covering adjacent the bottom edge; and
a plurality of outlet vents in the inner layer configured to direct air from the heat trapping space to outside of the liner, the outlet vents located in an upper part of the torso covering portion between the sleeves and beneath a neckline of the liner.

10. The liner of claim 9, wherein the inner layer has a front configured to extend over the front in a torso of a wearer and a back configured to extend over the back of the torso of the wearer, and the inlet and outlet vents are located in both the front and the back of the inner layer.

11. The liner of claim 9, wherein the inlet vents are located in the front and the back of the inner layer in either side of a median plane that divides the liner into a left side and a right side, and the outlet vents are located in the front and the back of the inner layer in either side of the median plane.

12. The liner of claim of claim 11, wherein one of the inlet vents and one of the outlet vents are located in the left side of the front of the inner layer, one of the inlet vents and one of the outlet vents is located in the right side of the front of the inner layer, one of the inlet vents and one of the outlet vents is located in the left side of the back of the inner layer, and one of the inlet vents and one of the outlet vents is located in the right side of the inner layer.

13. (canceled)

14. (canceled)

15. The liner of claim 9, wherein each sleeve has an underarm bellows located between the torso covering portion and the inlet vent in the sleeve.

16. A garment comprising:
a multi-layer liner comprising:
an inner layer and one or more adjacent layer joined together around a periphery with a heat trapping space between the inner and one or more adjacent layers;
a plurality of inlet vents in the inner layer configured to direct air from outside of the liner/garment into the heat trapping space, the inlet vents located in a lower part of the liner/garment; and
a plurality of outlet vents in the inner layer configured to direct air from the heat trapping space to outside of the liner/garment, the outlet vents located in an upper part of the garment.

17. The garment of claim 16 where the garment has a garment type selected from among: a coat, a liner for use in an outer shell of a coat, a pant, a liner for use in an outer shell of a pant, a bib overall, a liner for use in an outer shell of a bib overall, a jumpsuit/coverall, and a liner for use in an outer shell of a jumpsuit/coverall.

18. The garment of claim 16, wherein the liner layer comprises a face cloth quilted to a thermal layer, the thermal layer facing the heat trapping space.

19. The garment of claim 16, wherein each vent comprises an opening formed in the inner layer and a backup panel overlaying the opening and located in a side of the inner layer facing the heat trapping space.

20. The garment of claim 19, wherein each of the openings has an elongate rectangular perimeter.

21. The garment of claim 20, wherein the perimeter of each opening is defined by a welt.

22. (canceled)

23. (canceled)

24. The garment of claim 16, the liner further comprising:
a plurality of elongate spacer strips located in the heat trapping space, the spacer strips arranged to direct an airflow from the inlet vents toward the outlet vents.

25. The garment of claim 16 wherein the spacer strips are fixed to the inner layer.
